(19) United States
(12) Patent Application Publication
(10) Pub. No.: US 2026/0176468 A1
(43) Pub. Date: Jun. 25, 2026

(54) CERAMIZABLE SILICONE RUBBER, PREPARATION METHOD AND USE THEREOF

(71) Applicants: Guangxi Longsun Special New Material Technology Co., Ltd., Beihai (CN); Dongguan Longsun Material Technology Co., Ltd., Dongguan (CN)

(72) Inventors: Hebin Pan, Beihai (CN); Zhengxin Tan, Dongguan (CN)

(21) Appl. No.: 19/307,490

(22) Filed: Aug. 22, 2025

(30) Foreign Application Priority Data
Dec. 24, 2024 (CN) 202411918470.6

(51) Int. Cl. C08L 83/06; C08K 3/11; C08K 3/18; C08K 3/34; C08K 3/40; C08K 5/09; C08K 5/5415; C08K 5/5425

(52) U.S. Cl. CPC C08L 83/06; C08K 3/11; C08K 3/18; C08K 3/34; C08K 3/346; C08K 3/40; C08K 5/09; C08K 5/5415; C08K 5/5425

(57) ABSTRACT

A ceramizable silicone rubber and a preparation method and use thereof are provided. The ceramizable silicone rubber is prepared from raw materials including, in parts by mass: 90-105 parts of a methyl vinyl silicone rubber; 35-45 parts of fumed silica; 3-10 parts of a hydroxy silicone oil; 0.1-8 parts of a silane coupling agent; 1-75 parts of an inorganic filler, including mica powder, montmorillonite and wollastonite; 10-30 parts of a low-melting glass powder, having a melting point of 400° C. to 600° C., and including at least one selected from the group consisting of a borate glass powder and a phosphate glass powder; 0.1-0.3 parts of a platinum flame retardant, a mass content of platinum in the platinum flame retardant ranging from 1,000 ppm to 3,000 ppm; 0.5-1.5 parts of a vulcanizing agent; and 0.1-0.5 parts of an internal mold release agent.

### CROSS REFERENCE TO RELATED APPLICATION

This patent application claims the benefit and priority of Chinese Patent Application No. 202411918470.6 filed with the China National Intellectual Property Administration on Dec. 24, 2024, and entitled with “CERAMIZABLE SILICONE RUBBER, PREPARATION METHOD AND USE THEREOF”, the disclosure of which is incorporated by reference herein in its entirety as part of the present application.

### TECHNICAL FIELD

The present disclosure relates to the technical field of functional materials, and in particular to a ceramizable silicone rubber, and a preparation method and use thereof.

### BACKGROUND

Ceramizable silicone rubber is typically made from silicone rubber, a ceramic filler, and a fluxing agent, and shows excellent properties such as insulation properties, aging resistance, arc resistance, ablation resistance, and high and low temperature resistance. The ceramizable silicone rubber can rapidly undergo ceramification to form a ceramic shell being burned, providing excellent fireproofing and thermal insulation effects. Therefore, the ceramizable silicone rubber is widely applicable in the wire and cable industry, particularly in scenarios where high flame-retardant ratings and fire-resistant performance are required. In places where cables are densely laid, it is extremely easy to cause fire, so these cable laying sites have higher requirements for the flame retardant and fire-resistant performance of cables. In addition, in order to adapt to various use scenarios and installation conditions, the ceramizable silicone rubber is often required to have excellent mechanical properties. However, the ceramizable silicone rubber in the prior art often cannot have both excellent mechanical properties and ceramic properties, such as insufficient tensile strength and elongation at break, or a ceramic shell that is prone to cracking.

### SUMMARY

Objects of the present disclosure are to provide a ceramizable silicone rubber, and a preparation method and use thereof. The ceramizable silicone rubber provided by the present disclosure can maintain high tensile strength and elongation at break on the basis of ensuring good ceramic properties.

In order to achieve the above objects, the present disclosure provides the following technical solutions:

The present disclosure provides a ceramizable silicone rubber, prepared from raw materials including, in parts by mass:
90-105 parts of a methyl vinyl silicone rubber;
35-45 parts of fumed silica;
3-10 parts of a hydroxy silicone oil;
0.1-8 parts of a silane coupling agent;
1-75 parts of an inorganic filler, where the inorganic filler includes mica powder, montmorillonite and wollastonite;
10-30 parts of a low-melting glass powder, where the low-melting glass powder has a melting point of 400° C. to 600° C., and the low-melting glass powder includes at least one selected from the group consisting of a borate glass powder and a phosphate glass powder;
0.1-0.3 parts of a platinum flame retardant, where a mass content of platinum in the platinum flame retardant is in a range of 1,000 ppm to 3,000 ppm;
0.5-1.5 parts of a vulcanizing agent; and
0.1-0.5 parts of an internal mold release agent.

In some embodiments, a mass ratio of the mica powder, the montmorillonite and the wollastonite is in a range of 15-25:15-25:15-25.

In some embodiments, the methyl vinyl silicone rubber has a molar content of vinyl of 0.01% to 0.3%; and the methyl vinyl silicone rubber has a number average molecular weight of 600,000-700,000.

In some embodiments, the fumed silica has a particle size of 10 nm to 50 nm, and a specific surface area of 200 m²/g to 300 m²/g.

In some embodiments, the silane coupling agent includes at least one selected from the group consisting of vinyltrimethoxysilane, vinyltriethoxysilane and butadienyl triethoxysilane.

In some embodiments, the vulcanizing agent is an organic peroxide.

In some embodiments, the internal mold release agent includes zinc stearate and stearic acid, and a mass ratio of the zinc stearate to the stearic acid is in a range of 2:1 to 2.5:1.

The present disclosure provides a method for preparing the ceramizable silicone rubber described in the above technical solution, including:
mixing the methyl vinyl silicone rubber, the fumed silica, the hydroxy silicone oil, the silane coupling agent, the inorganic filler, the low-melting glass powder, the platinum flame retardant, the vulcanizing agent, and the internal mold release agent to obtain a mixed material; and
vulcanizing the mixed material to obtain the ceramizable silicone rubber.

In some embodiments, the mixing includes: subjecting the methyl vinyl silicone rubber, the hydroxy silicone oil, the fumed silica, and the internal mold release agent to a first mixing to obtain a first mixed material; subjecting the first mixed material, the silane coupling agent, the inorganic filler, the low-melting glass powder, and the platinum flame retardant to a second mixing to obtain a second mixed material; and subjecting the second mixed material and the vulcanizing agent to a third mixing; and
the vulcanizing includes: subjecting the mixed material to a first vulcanization and a second vulcanization in sequence, where the first vulcanization is conducted at a temperature of 100° C. to 120° C. for 60 min to 90 min; and the second vulcanization is conducted at a temperature of 180° C. to 220° C. for 90 min to 120 min.

The present disclosure provides use of the ceramizable silicone rubber described in the above technical solution or the ceramizable silicone rubber prepared by the method described in the above technical solution in wires and cables or new energy vehicles.

The present disclosure provides a ceramizable silicone rubber, prepared from raw materials including, in parts by mass: 90-105 parts of methyl vinyl silicone rubber; 35-45 parts of fumed silica; 3-10 parts of a hydroxy silicone oil; 0.1-8 parts of a silane coupling agent; 1-75 parts of an inorganic filler, where the inorganic filler includes mica powder, montmorillonite and wollastonite; 10-30 parts of a low-melting glass powder, where the low-melting glass powder has a melting point of 400° C. to 600° C., and the low-melting glass powder includes at least one selected from the group consisting of a borate glass powder and a phosphate glass powder; 0.1-0.3 parts of a platinum flame retardant, where a mass content of platinum in the platinum flame retardant is in a range of 1,000 ppm to 3,000 ppm; 0.5-1.5 parts of a vulcanizing agent; and 0.1-0.5 parts of an internal mold release agent. In the present disclosure, the methyl vinyl silicone rubber, which is used as a matrix material, is compounded with the fumed silica, the hydroxy silicone oil, the silane coupling agent, the platinum flame retardant, the vulcanizing agent and specific types of the inorganic filler and the low-melting glass powder to prepare the ceramizable silicone rubber. The ceramizable silicone rubber can maintain high tensile strength and elongation at break on the basis of ensuring good ceramic properties.

### DETAILED DESCRIPTION OF THE EMBODIMENTS

The present disclosure provides a ceramizable silicone rubber, prepared from raw materials including, in parts by mass:
90-105 parts of a methyl vinyl silicone rubber;
35-45 parts of fumed silica;
3-10 parts of a hydroxy silicone oil;
0.1-8 parts of a silane coupling agent;
1-75 parts of an inorganic filler, where the inorganic filler includes mica powder, montmorillonite and wollastonite;
10-30 parts of a low-melting glass powder, where the low-melting glass powder has a melting point of 400° C. to 600° C., and the low-melting glass powder includes at least one selected from the group consisting of a borate glass powder and a phosphate glass powder;
0.1-0.3 parts of a platinum flame retardant, where a mass content of platinum in the platinum flame retardant is in a range of 1,000 ppm to 3,000 ppm;
0.5-1.5 parts of a vulcanizing agent; and
0.1-0.5 parts of an internal mold release agent.

In the present disclosure, unless otherwise specified, the raw materials used for the preparation are commercially available products well-known to those skilled in the art.

In the present disclosure, the raw materials for the preparation of the ceramizable silicone rubber include, in parts by mass, 90-105 parts of methyl vinyl silicone rubber, which specifically may be 90 parts, 93 parts, 95 parts, 98 parts, 100 parts, 102 parts, or 105 parts. As an embodiment of the present disclosure, the methyl vinyl silicone rubber has a molar content of vinyl of 0.01-0.3%, specifically 0.01%, 0.03%, 0.05%, 0.08%, 0.1%, 0.2%, or 0.3%; and the methyl vinyl silicone rubber has a number average molecular weight of 600,000 to 700,000, specifically 600,000, 630,000, 650,000, 670,000, or 700,000. In the present disclosure, the methyl vinyl silicone rubber, which is used as a matrix material, is compounded with the fumed silica, the hydroxy silicone oil, the silane coupling agent, the platinum flame retardant, the vulcanizing agent and specific types of the inorganic filler and the low-melting glass powder to prepare the ceramizable silicone rubber. The ceramizable silicone rubber can be converted into an inorganic ceramic material under high temperature conditions, forming a hard protective layer, which is beneficial to isolating flame and heat.

In the present disclosure, based on the mass parts of the ceramizable silicone rubber, the raw materials for the preparation of the ceramizable silicone rubber include 35-45 parts of fumed silica, which specifically may be 30 parts, 31 parts, 32 parts, 33 parts, 34 parts, 35 parts, 36 parts, 37 parts, 38 parts, 39 parts, 40 parts, 41 parts, 42 parts, 43 parts, 44 parts, or 45 parts. As an embodiment of the present disclosure, the fumed silica has a particle size of 10 nm to 50 nm, specifically 10 nm, 20 nm, 30 nm, 40 nm or 50 nm; and the fumed silica has a specific surface area of 200 m²/g to 300 m²/g, specifically 200 m²/g, 250 m²/g, or 300 m²/g. In some embodiments of the present disclosure, the use of the fumed silica having the particle size and specific surface area described above can fill the voids in the methyl vinyl silicone rubber to form a more compact structure, which is advantageous for improving the strength and the abrasion and weather resistance of the product.

In the present disclosure, based on the mass part of the ceramizable silicone rubber, the raw materials for the preparation of the ceramizable silicone rubber include 3-10 parts of a hydroxy silicone oil, which specifically is 3 parts, 4 parts, 5 parts, 6 parts, 7 parts, 8 parts, 9 parts, or 10 parts. In the present disclosure, the use of the above-mentioned amounts of the hydroxy silicone oil can improve the processing and physical properties of the methyl vinyl silicone rubber and is beneficial to the uniform dispersion of the fumed silica in the methyl vinyl silicone rubber, thus preventing the structuring of the methyl vinyl silicone rubber and reducing permanent deformation.

In the present disclosure, based on the mass part of the ceramizable silicone rubber, the raw materials for the preparation of the ceramizable silicone rubber include 0.1-8 parts of a silane coupling agent, which specifically is 0.1 parts, 1 part, 2 parts, 3 parts, 4 parts, 5 parts, 6 parts, 7 parts, or 8 parts. As an embodiment of the present disclosure, the silane coupling agent includes at least one selected from the group consisting of vinyltrimethoxysilane, vinyltriethoxysilane and butadienyl triethoxysilane, specifically vinyltrimethoxysilane. In the present disclosure, the use of the above-mentioned amounts of the silane coupling agent can enhance the physical properties and aging resistance of the product, such as enhancing the toughness, strength, and ductility of the product, improving the aging resistance at high temperatures and under UV light, and extending service life.

In the present disclosure, based on the mass part of the ceramizable silicone rubber, the raw materials for the preparation of the ceramizable silicone rubber include 1-75 parts, further 40-75 parts, of an inorganic filler, which specifically is 40 parts, 45 parts, 50 parts, 55 parts, 60 parts, 65 parts, 70 parts, or 75 parts; the inorganic filler includes mica powder, montmorillonite and wollastonite, and a mass ratio of the mica powder, the montmorillonite and the wollastonite is in a range of 15-25:15-25:15-25, specifically 1:1:1; and the inorganic filler has a particle size of 8 μm to 12 μm, specifically 10 μm. In the present disclosure, the mica powder, the montmorillonite, and the wollastonite are compounded and used as an inorganic filler, which can form a hard ceramic protective layer under high temperature conditions, preventing the further decomposition of the methyl vinyl silicone rubber, thus being beneficial to improving the thermal stability and fire resistance of the product.

In the present disclosure, based on the mass part of the ceramizable silicone rubber, the raw materials for the preparation of the ceramizable silicone rubber include 10-30 parts of a low-melting glass powder, which specifically is 10 parts, 11 part, 12 parts, 13 parts, 14 parts, 15 parts, 20 parts, 25 parts, or 30 parts; and the low-melting glass powder has a melting point of 400° C. to 600° C., which specifically is 450° C.; and the low-melting glass powder includes at least one selected from the group consisting of a borate glass powder and a phosphate glass powder, specifically a phosphate glass powder. In contrast to the use of a silicate glass powder, the aforementioned low-melting glass powder used in the present disclosure can form a dense and hard ceramic body structure under high temperature conditions, which can resist at least 1000° C. high temperature and has a good flame retardant effect, thereby further preventing the combustion and oxidation of the material, thus enabling the material to have a flame retardant effect.

In the present disclosure, based on the mass part of the ceramizable silicone rubber, the raw materials for the preparation of the ceramizable silicone rubber include 0.1-0.3 parts of a platinum flame retardant, which specifically is 0.1 parts, 0.2 parts, or 0.3 parts; and a mass content of platinum in the platinum flame retardant is in a range of 1,000 ppm to 3,000 ppm, which specifically is 1,000 ppm, 1,500 ppm, 2,000 ppm, 2,500 ppm, or 3,000 ppm. In some embodiments of the present disclosure, the use of the platinum flame retardant in the above-mentioned amount and platinum content can improve the flame retardant performance and thermal stability of the product, facilitate catalytic carbon formation, protect the unburned part, and reduce the cracking and oxidation reaction of the product under high-temperature conditions.

In the present disclosure, based on the mass part of the ceramizable silicone rubber, the raw materials for the preparation of the ceramizable silicone rubber include 0.5-1.5 parts of a vulcanizing agent, which specifically is 0.5 parts, 1 part, or 1.5 parts. As an embodiment of the present disclosure, the vulcanizing agent is an organic peroxide, and the organic peroxide is 2,4-dichlorobenzoyl peroxide. In an embodiment of the present disclosure, the above-mentioned amounts and types of the vulcanizing agent used can decompose under high-temperature conditions to produce free radicals, which form crosslinks with the organic pendant groups of the methyl vinyl silicone rubber, thereby obtaining properties of silica gel. In addition, it is advantageous to allow the product to have characteristics such as high strength, no bubbles, good transparency, and stable physical properties after secondary vulcanization.

In the present disclosure, based on the mass part of the ceramizable silicone rubber, the raw materials for the preparation of the ceramizable silicone rubber include 0.1-0.5 parts of an internal mold release agent, which specifically is 0.1 parts, 0.2 parts, 0.3 parts, 0.4 parts, or 0.5 parts. As an embodiment of the present disclosure, the internal mold release agent includes zinc stearate and stearic acid, and a mass ratio of the zinc stearate to the stearic acid is in a range of 2-2.5:1, specifically 2:1. In some embodiments of the present disclosure, the use of the above-mentioned amounts and types of the internal mold release agent can reduce the degree of adhesion of the methyl vinyl silicone rubber in the mold, thus facilitating easier product removal from the mold.

The present disclosure provides a method for preparing the ceramizable silicone rubber described in the above technical solution, including the following steps:
mixing the methyl vinyl silicone rubber, the fumed silica, the hydroxy silicone oil, the silane coupling agent, the inorganic filler, the low-melting glass powder, the platinum flame retardant, the vulcanizing agent, and the internal mold release agent to obtain a mixed material; and
vulcanizing the mixed material to obtain the ceramizable silicone rubber.

In the present disclosure, methyl vinyl silicone rubber, fumed silica, a hydroxy silicone oil, a silane coupling agent, an inorganic filler, a low-melting glass powder, a platinum flame retardant, a vulcanizing agent and an internal mold release agent are mixed to obtain a mixed material. As an embodiment of the present disclosure, the mixing includes: subjecting the methyl vinyl silicone rubber, the hydroxy silicone oil, the fumed silica, and the internal mold release agent to a first mixing to obtain a first mixed material; subjecting the first mixed material, the silane coupling agent, the inorganic filler, the low-melting glass powder, and the platinum flame retardant to a second mixing to obtain a second mixed material; and subjecting the second mixed material and the vulcanizing agent to a third mixing to obtain the mixed material (designated as a third mixed material).

As an embodiment of the present disclosure, specifically, the methyl vinyl silicone rubber is kneaded first, followed by a resulting kneaded material, the hydroxy silicone oil, the fumed silica, and the an internal mold release agent are subjected to a first mixing; the kneading is conducted at a temperature of 130° C. to 150° C., specifically 130° C., 135° C., 140° C., 145° C., or 150° C.; and the kneading is conducted for 1 h to 3 h, specifically 1 h, 2 h, or 3 h; the first mixing is conducted at a temperature of 130° C. to 150° C., specifically 130° C., 135° C., 140° C., 145° C., or 150° C.; and the first mixing is conducted for 2 h to 3 h; and the kneading and the first mixing particularly are conducted in a kneader.

As an embodiment of the present disclosure, the second mixing is conducted at a temperature of 150° C. to 170° C., specifically 150° C., 155° C., 160° C., 165° C., or 170° C.; and the second mixing is conducted for 0.5 h to 2 h, specifically 0.5 h, 1 h, or 2 h; and the second mixing particularly is conducted in a kneader.

As an embodiment of the present disclosure, the method further includes conducting a vacuum treatment between the second mixing and the third mixing; the vacuum treatment is conducted at a temperature of 150° C. to 160° C., specifically 150° C., 155° C., or 160° C.; the vacuum treatment is conducted for 1 h to 1.5 h; and a vacuum degree during the vacuum treatment ranges from −0.05 MPa to −0.08 MPa, specifically −0.05 MPa, −0.06 MPa, −0.07 MPa, or −0.08 MPa. The vacuum treatment helps remove the small molecules in the raw rubber, the moisture in the fumed silica, and the low-boiling by-products produced in the mixing process, thus ensuring that the rubber compound has more stable properties.

As an embodiment of the present disclosure, the third mixing is conducted at a temperature of 20° C. to 40° C., specifically 20° C., 30° C., or 40° C.; the third mixing is conducted for 15 min to 20 min; and the third mixing particularly is conducted in an open mill.

In the present disclosure, after obtaining the mixed material, the mixed material is vulcanized to obtain the ceramizable silicone rubber. As an embodiment of the present disclosure, the vulcanizing includes: subjecting the mixed material to a first vulcanization and a second vulcanization in sequence. In some embodiments of the present disclosure, the function of two vulcanization steps is to further cross-link and eliminate low-molecular compounds. As an embodiment of the present disclosure, the first vulcanization is conducted at a temperature of 100° C. to 120° C., specifically 100° C., 110° C., or 120° C.; the first vulcanization is conducted for 60 min to 90 min, specifically 60 min, 70 min, 80 min, or 90 min; and the first vulcanization particularly is conducted on a plate vulcanizing press. As an embodiment of the present disclosure, the second vulcanization is conducted at a temperature of 180° C. to 220° C., specifically 180° C., 190° C., 200° C., 210° C., or 220° C.; the second vulcanization is conducted for 90 min to 120 min, specifically 90 min, 100 min, 110 min, or 120 min; and the second vulcanization particularly is conducted in an oven.

The ceramizable silicone rubber provided by the present disclosure can be sintered into a hard ceramic shell after being burned by an open flame. The ceramic shell is hard, can withstand a certain intensity of vibration, and does not crack or fall off after being exposed to rain. Moreover, the ceramizable silicone rubber of the present disclosure has good electrical properties. In addition, the preparation process of the ceramizable silicone rubber described in the present disclosure is simple, with low production costs.

The present disclosure provides use of the ceramizable silicone rubber described in the above technical solution or the ceramizable silicone rubber prepared by the method described in the above technical solution in wires and cables or new energy vehicles. There is no special limitation on the specific use methods of the ceramizable silicone rubber, and any method that is well known to those skilled in the art may be used.

The technical solutions in the present disclosure will be described clearly and completely below with reference to the examples of the present disclosure. Apparently, the described examples are merely some, rather than all of the examples of the present disclosure. On the basis of the embodiments of the present disclosure, all other embodiments that can be obtained by those of ordinary skill in the art without creative efforts shall fall within the scope of the present disclosure.

### Example 1

Raw materials for preparing a ceramizable silicone rubber in this example consisted of, in parts by weight:
100 parts of methyl vinyl silicone rubber, 30 parts of fumed silica, 10 parts of a low-melting glass powder, 60 parts of an inorganic filler, 6 parts of a hydroxy silicone oil, 6 parts of a silane coupling agent, 0.1 parts of a platinum flame retardant, 0.3 parts of an internal mold release agent, and 0.5 parts of a vulcanizing agent.

The methyl vinyl silicone rubber had a molar content of vinyl of 0.05% and a number average molecular weight of 650,000; the fumed silica had a particle size of 10 nm and a specific surface area of 200 m²/g; the low-melting glass powder was a phosphate glass powder with a melting point of 450° C.; the inorganic filler was a mixture of montmorillonite, wollastonite and mica powder in a mass ratio of 1:1:1; the silane coupling agent was vinyltrimethoxysilane; a mass content of platinum in the platinum flame retardant was 1,500 ppm; the internal mold release agent was a mixture of zinc stearate and stearic acid in a mass ratio of 2:1; and the vulcanizing agent was 2,4-dichlorobenzoyl peroxide.

The ceramizable silicone rubber in this example was prepared by a method as follows:
(1) Methyl vinyl silicone rubber was added to a kneader and kneaded at 60° C. for 5 min, and a hydroxy silicone oil, a silane coupling agent, and an internal mold release agent were then added to the kneader and mixed at 130° C. for 2 h to obtain a first mixed material.
(2) A silane coupling agent, an inorganic filler, a low-melting glass powder, and a platinum flame retardant were added to the first mixed material and mixed at 150° C. for 1 h to obtain a second mixed material.
(3) The second mixed material was subjected to a vacuum treatment at 160° C. for 1 h with a vacuum degree being-0.06 MPa. A resulting glue stock was cooled and then placed in an open mill, and then a vulcanizing agent was added to the open mill and mixed at 30° C. for 15 min to obtain a third mixed material.
(4) The third mixed material was preformed, then placed on a plate vulcanizing press and heated at 110° C. for vulcanization for 1 h, and then placed in an oven for secondary vulcanization at 200° C. for 1.5 h to obtain the ceramizable silicone rubber.

### Example 2

Raw materials for preparing a ceramizable silicone rubber in this example consisted of, in parts by weight:
100 parts of methyl vinyl silicone rubber, 35 parts of fumed silica, 10 parts of a low-melting glass powder, 45 parts of an inorganic filler, 8 parts of a hydroxy silicone oil, 4 parts of a silane coupling agent, 0.2 parts of a platinum flame retardant, 0.3 parts of an internal mold release agent, and 1 part of a vulcanizing agent.

The methyl vinyl silicone rubber had a molar content of vinyl of 0.08% and a number average molecular weight of 650,000; the fumed silica had a particle size of 10 nm and a specific surface area of 200 m²/g; the low-melting glass powder was a phosphate glass powder with a melting point of 450° C.; the inorganic filler was a mixture of montmorillonite, wollastonite and mica powder in a mass ratio of 1:1:1; the silane coupling agent was vinyltrimethoxysilane; a mass content of platinum in the platinum flame retardant was 1,500 ppm; the internal mold release agent was a mixture of zinc stearate and stearic acid in a mass ratio of 2:1; and the vulcanizing agent was 2,4-dichlorobenzoyl peroxide.

The ceramizable silicone rubber in this example was prepared according to the method in Example 1.

### Example 3

Raw materials for preparing a ceramizable silicone rubber in this example consisted of, in parts by weight:
100 parts of methyl vinyl silicone rubber, 25 parts of fumed silica, 10 parts of a low-melting glass powder, 75 parts of an inorganic filler, 5 parts of a hydroxy silicone oil, 8 parts of a silane coupling agent, 0.2 parts of a platinum flame retardant, 0.3 parts of an internal mold release agent, and 1 part of a vulcanizing agent.

The methyl vinyl silicone rubber had a molar content of vinyl of 0.05% and a number average molecular weight of 650,000; the fumed silica had a particle size of 10 nm and a specific surface area of 200 m²/g; the low-melting glass powder was a phosphate glass powder with a melting point of 450° C.; the inorganic filler was a mixture of montmorillonite, wollastonite and mica powder in a mass ratio of 1:1:1; the silane coupling agent was vinyltrimethoxysilane; a mass content of platinum in the platinum flame retardant was 2,000 ppm; the internal mold release agent was a mixture of zinc stearate and stearic acid in a mass ratio of 2:1; and the vulcanizing agent was 2,4-dichlorobenzoyl peroxide.

The ceramizable silicone rubber in this example was prepared according to the method in Example 1.

### Example 4

Raw materials for preparing a ceramizable silicone rubber in this example consisted of, in parts by weight:
100 parts of methyl vinyl silicone rubber, 30 parts of fumed silica, 10 parts of a low-melting glass powder, 75 parts of an inorganic filler, 6 parts of a hydroxy silicone oil, 8 parts of a silane coupling agent, 0.2 parts of a platinum flame retardant, 0.3 parts of an internal mold release agent, and 1 part of a vulcanizing agent.

The methyl vinyl silicone rubber had a molar content of vinyl of 0.08% and a number average molecular weight of 650,000; the fumed silica had a particle size of 10 nm and a specific surface area of 200 m²/g; the low-melting glass powder was a phosphate glass powder with a melting point of 450° C.; the inorganic filler was a mixture of montmorillonite, wollastonite and mica powder in a mass ratio of 1:1:1; the silane coupling agent was vinyltrimethoxysilane; a mass content of platinum in the platinum flame retardant was 2,500 ppm; the internal mold release agent was a mixture of zinc stearate and stearic acid in a mass ratio of 2:1; and the vulcanizing agent was 2,4-dichlorobenzoyl peroxide.

The ceramizable silicone rubber in this example was prepared according to the method in Example 1.

### Example 5

Raw materials for preparing a ceramizable silicone rubber in this example consisted of, in parts by weight:
100 parts of methyl vinyl silicone rubber, 35 parts of fumed silica, 10 parts of a low-melting glass powder, 60 parts of an inorganic filler, 7 parts of a hydroxy silicone oil, 6 parts of a silane coupling agent, 0.2 parts of a platinum flame retardant, 0.3 parts of an internal mold release agent, and 1 part of a vulcanizing agent,
where the methyl vinyl silicone rubber had a molar content of vinyl of 0.05% and a number average molecular weight of 650,000; the fumed silica had a particle size of 10 nm and a specific surface area of 200 m²/g; the low-melting glass powder was a phosphate glass powder with a melting point of 450° C.; the inorganic filler was a mixture of montmorillonite, wollastonite and mica powder in a mass ratio of 1:1:1; the silane coupling agent was vinyltrimethoxysilane; a mass content of platinum in the platinum flame retardant was 3,000 ppm; the internal mold release agent was a mixture of zinc stearate and stearic acid in a mass ratio of 2:1; and the vulcanizing agent was 2,4-dichlorobenzoyl peroxide.

The ceramizable silicone rubber in this example was prepared following the method in Example 1.

### Comparative Example 1

This example was carried out according to the method in Example 5, except that the low-melting glass powder was omitted.

### Comparative Example 2

This example was carried out according to the method in Example 5, except that the platinum flame retardant was omitted.

### Comparative Example 3

This example was carried out according to the method in Example 5, and the phosphate glass powder (with a melting point of 450° C.) in Comparative example 5 was replaced with a silicate glass powder (with a melting point of 500° C.).

### Comparative Example 4

This example was carried out according to the method in Example 5, except that the inorganic filler was a mixture of wollastonite and mica powder in a mass ratio of 1:1.

### Test Example 1

The properties of the ceramizable silicone rubbers prepared in the examples and comparative examples were tested, and the test results are shown in Table 1. The tensile strength and the elongation at break were tested according to the GB/T 1040 method; the breakdown strength was tested according to the GB/T 1408 method; and the ceramic flexural strength was tested according to the GB/T 6569-2006 method. The ceramic appearance was specifically evaluated by hand touching and by listening to the sound upon falling to the ground. If the ceramizable silicone rubber felt hard when touched by hand and produced a crisp sound, it indicated that the ceramizable silicone rubber was hard. Meanwhile, after the ceramizable silicone rubber fell to the ground, a visual inspection was carried out to check for any cracks. If no crack was observed, it indicated that the ceramizable silicone rubber was intact.

TABLE 1
Test results of properties of ceramizable silicone
rubbers in examples and comparative examples

| | | Elonga- | | Ceramic | |
|---|---|---|---|---|---|
| | Tensile | tion at | Breakdown | flexural | |
| Sample | strength | break | strength | strength | Ceramic |
| source | (MPa) | (%) | (MV/m) | (MPa) | appearance |
| Example 1 | 7.6 | 352 | 32 | 9.2 | Intact and hard |
| Example 2 | 8.4 | 302 | 34 | 10.7 | Intact and hard |
| Example 3 | 7.2 | 288 | 31 | 11.4 | Intact and hard |
| Example 4 | 7.4 | 265 | 30 | 11.5 | Intact and hard |
| Example 5 | 8.2 | 368 | 32 | 11.6 | Intact and hard |
| Comparative | 7.8 | 368 | 32 | 11.3 | Hard, with |
| example 1 | | | | | large cracks |
| Comparative | 7.5 | 354 | 33 | 4.6 | Intact but not |
| example 2 | | | | | hard |
| Comparative | 7.1 | 306 | 32 | 9.1 | Intact and hard |
| example 3 | | | | | |
| Comparative | 7.8 | 338 | 30 | 10.8 | Intact and hard |
| example 4 | | | | | |

As can be seen from Table 1, the ceramizable silicone rubbers prepared in Examples 1-5 of the present disclosure can maintain high tensile strength and elongation at break on the premise of ensuring the hardness of the ceramic shell.

In addition, it can be seen from Table 1 that the ceramizable silicone rubber prepared without the use of a glass powder in Comparative example 1 had a poor ceramic appearance, featuring large surface cracks. The ceramizable silicone rubber prepared without the use of a platinum flame retardant in Comparative example 2 had poor flame retardant performance and poor ceramic strength. The ceramizable silicone rubber prepared using a silicate glass powder in Comparative example 3 had decreased tensile strength and elongation at break. The ceramizable silicone rubber prepared using an inorganic filler containing no montmorillonite in Comparative Example 4 had reduced elongation at break and breakdown strength.

The descriptions above are merely the preferred embodiments of the present disclosure. It should be noted that several improvements and modifications may also be made by those of ordinary skill in the art without departing from the principle of the present disclosure, and these improvements and modifications should also be considered within the scope of the present disclosure.

What is claimed is:

1. A ceramizable silicone rubber, prepared from raw materials comprising, in parts by mass:
90-105 parts of a methyl vinyl silicone rubber;
35-45 parts of fumed silica;
3-10 parts of a hydroxy silicone oil;
0.1-8 parts of a silane coupling agent;
1-75 parts of an inorganic filler, wherein the inorganic filler comprises mica powder, montmorillonite and wollastonite;
10-30 parts of a low-melting glass powder, wherein the low-melting glass powder has a melting point of 400° C. to 600° C., and the low-melting glass powder comprises at least one selected from the group consisting of a borate glass powder and a phosphate glass powder;
0.1-0.3 parts of a platinum flame retardant, wherein a mass content of platinum in the platinum flame retardant is in a range of 1,000 ppm to 3,000 ppm;
0.5-1.5 parts of a vulcanizing agent; and
0.1-0.5 parts of an internal mold release agent.

2. The ceramizable silicone rubber of claim 1, wherein a mass ratio of the mica powder, the montmorillonite and the wollastonite is in a range of 15-25:15-25:15-25.

3. The ceramizable silicone rubber of claim 1, wherein the methyl vinyl silicone rubber has a molar content of vinyl of 0.01% to 0.3%; and the methyl vinyl silicone rubber has a number average molecular weight of 600,000 to 700,000.

4. The ceramizable silicone rubber of claim 1, wherein the fumed silica has a particle size of 10 nm to 50 nm, and a specific surface area of 200 m²/g to 300 m²/g.

5. The ceramizable silicone rubber of claim 1, wherein the silane coupling agent comprises at least one selected from the group consisting of vinyltrimethoxysilane, vinyltriethoxysilane and butadienyl triethoxysilane.

6. The ceramizable silicone rubber of claim 1, wherein the vulcanizing agent is an organic peroxide.

7. The ceramizable silicone rubber of claim 1, wherein the internal mold release agent comprises zinc stearate and stearic acid, and a mass ratio of the zinc stearate to the stearic acid is in a range of 2:1 to 2.5:1.

8. A method for preparing the ceramizable silicone rubber of claim 1, comprising:
mixing the methyl vinyl silicone rubber, the fumed silica, the hydroxy silicone oil, the silane coupling agent, the inorganic filler, the low-melting glass powder, the platinum flame retardant, the vulcanizing agent, and the internal mold release agent to obtain a mixed material; and
vulcanizing the mixed material to obtain the ceramizable silicone rubber.

9. The method of claim 8, wherein the mixing comprises: subjecting the methyl vinyl silicone rubber, the hydroxy silicone oil, the fumed silica, and the internal mold release agent to a first mixing to obtain a first mixed material; subjecting the first mixed material, the silane coupling agent, the inorganic filler, the low-melting glass powder, and the platinum flame retardant to a second mixing to obtain a second mixed material; and subjecting the second mixed material and the vulcanizing agent to a third mixing; and
the vulcanizing comprises: subjecting the mixed material to a first vulcanization and a second vulcanization in sequence, wherein the first vulcanization is conducted at a temperature of 100° C. to 120° C. for 60 minutes to 90 minutes; and the second vulcanization is conducted at a temperature of 180° C. to 220° C. for 90 minutes to 120 minutes.

10. The method of claim 8, wherein a mass ratio of the mica powder, the montmorillonite and the wollastonite is in a range of 15-25:15-25:15-25.

11. The method of claim 8, wherein the methyl vinyl silicone rubber has a molar content of vinyl of 0.01% to 0.3%; and the methyl vinyl silicone rubber has a number average molecular weight of 600,000 to 700,000.

12. The method of claim 8, wherein the fumed silica has a particle size of 10 nm to 50 nm, and a specific surface area of 200 m²/g to 300 m²/g.

13. The method of claim 8, wherein the silane coupling agent comprises at least one selected from the group consisting of vinyltrimethoxysilane, vinyltriethoxysilane and butadienyl triethoxysilane.

14. The method of claim 8, wherein the vulcanizing agent is an organic peroxide.

15. The method of claim 8, wherein the internal mold release agent comprises zinc stearate and stearic acid, and a mass ratio of the zinc stearate to the stearic acid is in a range of 2:1 to 2.5:1.
